(19) United States
(12) Patent Application Publication
(10) Pub. No.: US 2012/0155974 A1
(43) Pub. Date: Jun. 21, 2012

(54) DECELERATOR COMPRISING DECELERATION TANK AND EXTRACTION CONVEYOR

(76) Inventors: Vincent E. Bryan, JR., Mercer Island, WA (US); Tony Finazzo, Mercer Island, WA (US); Polly Allard, Mercer Island, WA (US); Marc Bommarito, Mercer Island, WA (US); Alex Kunzler, Mercer Island, WA (US); Randy Allard, Mercer Island, WA (US); Peter Kunzier, Mercer Island, WA (US); Vincent E. Bryan, III, Mercer Island, WA (US)

(21) Appl. No.: 13/145,216

(22) PCT Filed: Jan. 19, 2010
(86) PCT No.: PCT/US10/21412

§ 371 Date: Oct. 4, 2011

Related U.S. Application Data
(60) Provisional application No. 61/145,899, filed on Jan. 20, 2009.
(60) Provisional application No. 61/146,468, filed on Jan. 22, 2009.

(51) Int. Cl. B65G 53/36; B65G 53/44

(52) U.S. Cl. 406/82; 406/154

(57) ABSTRACT

A decelerator comprising a deceleration tank and an extraction conveyor is disclosed. The decelerator is adapted for use with apples or similar objects. These objects are delivered to the tank from a pneumatic tube transport system. The tank contains a quantity of liquid such as water. In one embodiment, the objects splash into the water and are extracted from the water by an extraction conveyor. In a second embodiment, a baffle gate divides the tank between a forward section and a rear section. The delivered objects splash into the water in the forward section, travel under the baffle gate, and are extracted from the water by an extraction conveyor in communication with the rear tank section. In another embodiment, the tank is divided into first, second and third sections by selectively appeasable gate which provides an air lock arrangement. The extraction conveyor can comprise a plurality of side belts and a plurality of foraminous, flexible cradles hung between the belts.

### RELATED CASES AND BACKGROUND OF THE INVENTION

This application claims priority from U.S. provisional patent application Ser. No. 61/145,899 filed Jan. 20, 2009 entitled “Deceleration Tank and Extraction Conveyor” and from U.S. provisional patent application Ser. No. 61/146,468 filed Jan. 22, 2009 entitled “Multi-Section Decelerator Tank.” The invention relates generally to decelerator devices for receiving relatively delicate objects such as apples from a pneumatic vacuum tube transport system and for transferring those decelerated objects to an extraction and conveyance device.

Fruit such as apples are traditionally hand-picked and gently handled. In accordance with widespread current practice, the picking personnel climb ladders and then carefully separate the apples or other fruit from the trees and then place the picked fruit in bags which are worn by the pickers. The pickers, carrying the filled fruit bags, then climb down their picking ladders, walk to a collecting bin, and then carefully and gently unload the fruit from the bags into the bin. The pickers then return to the ladders near the trees and repeat the cycle. In some environments, as much as 70% of the picker's time is spent in traveling from the tree to the bin, unloading the bag into the bin, and returning to the tree; in these environments, only 30% of the picker's time will be spent in actually picking fruit from the tree.

New systems have been developed which will greatly reduce the need for the pickers to move between the trees and bins. One family of such systems provides a pneumatic tube transport system. In use, the pickers are able to pick fruit substantially continuously; each picker deposits the picked fruit in a sleeve or other device which leads to a pneumatic transport tube. The picked fruit travels through the tube for further processing. The invention which is the subject of this patent application provides for the safe and gentle deceleration of the fruit traveling through the pneumatic tubes, so that the fruit can be further processed and then gently placed in a collecting bin.

It is contemplated that the invention described and claimed herein can be used with the invention described and claimed in U.S. provisional patent application Ser. No. 61/028,351 filed Feb. 13, 2008 entitled “Mobile System for Improving the Picking and Preliminary Processing of Apples, Citrus, Stone Fruit and like Objects,” which has been claimed as priority in follow-on U.S. Ser. No. 12/371,446 filed Feb. 13, 2009 with the same title, and also claimed as priority in follow-on PCT International Application No. PCT/US2009/034132 filed Feb. 13, 2009 entitled “Mobile System for Improving the Picking and Preliminary Processing of Apples, Citrus, Stone Fruit and Like Objects” now Publication No. WO 2009/103008 published on Aug. 20, 2009.

It is contemplated that the invention described and claimed herein can also be used with the invention described and claimed in U.S. provisional application Ser. No. 60/920,069 filed Mar. 26, 2007 entitled “Picking and/or Moving Device” and Ser. No. 60/949,630 filed Jul. 13, 2007 entitled “Modifications And Improvements To Membranes Inside Pneumatic Transport Tubes,” both of which were claimed as priority in U.S. utility patent application Ser. No. 12/055,209 filed Mar. 25, 2008, entitled “Transport System for Fruit and Like Objects” now Publication No. US-2008-0279640-A1 published on Nov. 13, 2008, and both also claimed as priority in follow-on PCT International Application No. PCT/US08/058,151 filed Mar. 25, 2008 entitled “Transport System for Fruit and Like Objects” now Publication No. WO 2008/118915 A1 published Oct. 2, 2009. All of the aforementioned applications are incorporated herein by reference. These novel delivery systems and this present invention are expected to substantially increase the productivity of the pickers, and favorably affect the economics of the fruit orchard business.

It is an object of this invention to provide mechanism and apparatus for receiving apples or other objects moving from the delivery end of a pneumatic tube system, for decelerating the motion of those objects, and for delivering those objects to a device such as an extraction conveyor for further transport and processing.

Another object of the invention is to provide an extraction conveyor which will gently collect and transport objects from the deceleration device so as to minimize bruising or other damage to the objects.

Another object of the invention is to provide a combined deceleration device and downstream extraction conveyor for gently handling fruit or like delicate objects.

Yet another object of this invention is to receive and decelerate the transported objects from the pneumatic tubes and then present the decelerated objects to downstream processing equipment operating in an ambient pressure environment, all without bruising or otherwise damaging the objects being transported and presented.

Another object of the invention is to provide apparatus which will reliably and inexpensively accomplish the foregoing tasks.

Other objects and advantages of the invention will become apparent upon reading the following detailed description and upon a reference to the drawings. Throughout the drawings, like reference numerals refer to like parts.

### BRIEF DESCRIPTION OF THE DRAWINGS

FIG. 1 is an elevational schematic view of an embodiment of the novel deceleration tank and extraction conveyor as they appear when incorporated into and used with the novel fruit transport and collection system.

FIG. 2 is a schematic side elevational view of the deceleration tank and extraction conveyor shown in FIG. 1. The sidewall has been omitted for clarity.

FIG. 3 is an isometric view of the deceleration tank and extraction conveyor shown in FIGS. 1 and 2.

FIG. 4 is a side elevational view of another embodiment of the invention. Sidewalls of the invention have been omitted for clarity.

FIGS. 5a and 5b are isometric views of gate mechanisms shown in FIG. 4.

FIG. 6 is an isometric view of an alternate embodiment of the invention shown in FIGS. 4, 5a and 5b.

FIG. 7 is an isometric view of the invention shown in FIGS. 4, 5a and 5b.

### DETAILED DESCRIPTION

While the invention will be described in connection with a preferred embodiment and procedure, it will be understood that it is not intended to limit the invention to this embodiment and procedure. On the contrary, it is intended to cover all alternatives, modifications and equivalents as may be included within the spirit and scope of the invention as defined by the appended claims.

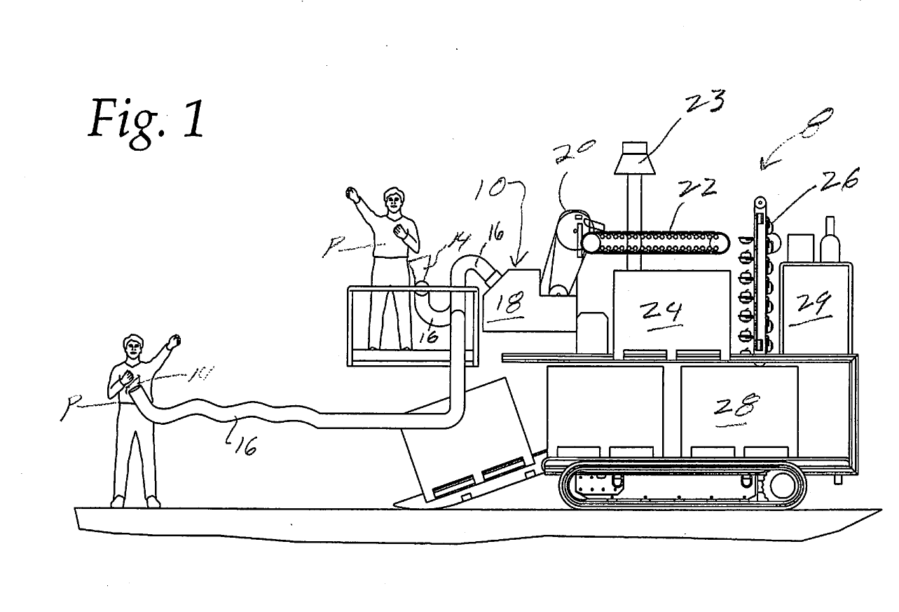

Turning first to FIG. 1, there is a mobile fruit harvester transport and management system 8 designed in accordance with the patent applications incorporated by reference and referred to above. This harvester system 8 includes a novel decelerator subsystem 10 here comprising a novel deceleration tank 18 and a novel extraction conveyor 20. Pickers P pick fruit such as apples from trees (not shown) and deposit the picked fruit in sleeves 14 or equivalent receivers which lead to pneumatic tubes 16. These pneumatic tubes 16 transport the fruit to the novel vacuum deceleration tank 18 and extraction conveyor 20 comprising the deceleration subsystem 10. Fruit extracted from the deceleration tank 18 by the extraction conveyor 20 is deposited upon a scanning cross conveyor 22 where it can be examined manually or by automated equipment 23. Fruit having blemishes or fruit of an undesired color or size can be diverted, or culled, into a cull dry bin 24. Desired fruit can be delivered to a dry bin conveyor 26 which places that fruit in a dry bin 28. The collection dry bin 28, when filled, can be placed on the ground for subsequent pick up by a vehicle which will take the filled dry bin 28 to a packing shed or other facility. An engine 29 provides power to the various conveyors and subsystems.

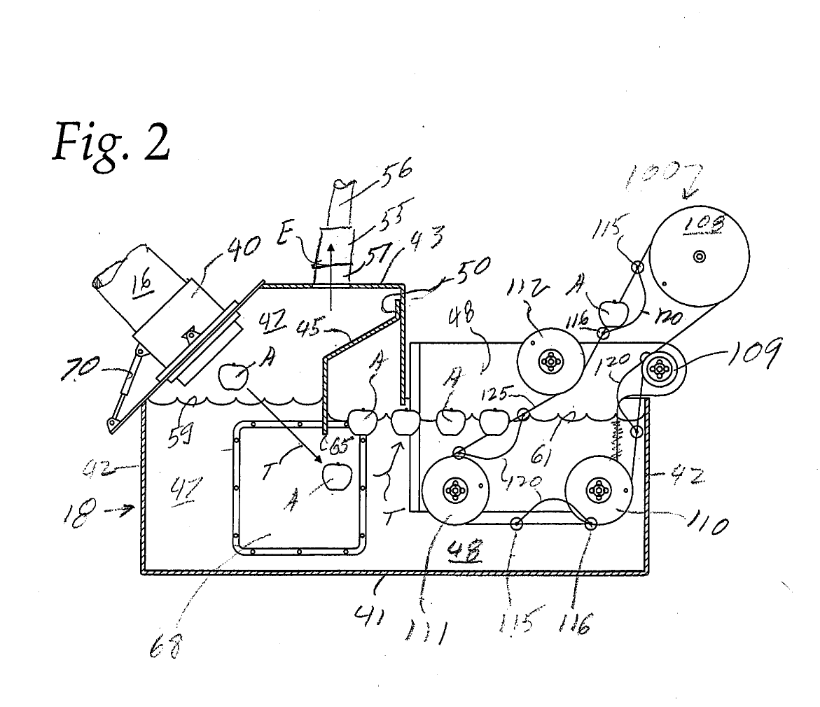

An embodiment of the deceleration tank 18 and extraction conveyor 20 are more particularly shown in FIG. 2. An adjustable inlet 40 connected to one or more pneumatic tubes 16 leads the traveling apples A or other fruit to the deceleration tank 18. The tank 18 is enclosed by a bottom 41, sides 42 and top 43. Within the tank 18, baffle gate 45 can be provided which divides the deceleration tank 18 into a forward section 47 and a rear section 48. At least part of the baffle gate 45 preferably extends at an angle (here, 45°) from a mount 50 inside the tank diagonally downward toward, but not completely to, the tank bottom 41. A suitable liquid (preferably water) partly fills the water bath tank 18, including the two intercommunicating sections 47 and 48. Cleansers, disinfectants, or other agents can be mixed in the water or other fluid if desired.

An exhaust connection 55 functionally communicates via tubing 56 with a remote conventional vacuum source (not shown) to provide a partial exhaust vacuum E in the forward section 47. Known adjustment means 57 such as an air flow valve can be provided to adjust the amount of vacuum over the liquid in the forward section 47. This decreased air pressure above the water causes the water level 59 in the forward section 47 to rise slightly above the water level 61 in the rear section 48. The partial vacuum also provides an air-pressure differential across the apples in the pneumatic transport tubing 16, causing them to travel toward and into the deceleration tank 18 in accordance with the patent applications referred to above.

In operation, the apples A or other objects traveling along the tube 16 are delivered by the tank inlet 40 to the forward section 47 of the water bath tank 18, where the apples splash into the water. As suggested by the arrows T, the apples are momentarily immersed in the water, and the momentum of their travel carries them angularly downwardly into the water and past a lower edge 65 of the baffle gate 45 and into the rear section 48 of the tank 18. The buoyancy of the apples carries them up to the surface 61 of the water in the rear section 48. Angle adjustment mechanism 70 permits the pneumatic tube gate delivery end and tank inlet 40 to be positioned relative to the surface of the water so that the incoming objects will travel under the baffle gate edge 65 and along the desired path of travel T. An observation window 68 can be provided in the tank wall to permit the system operator to check for sunken apples, debris, or system malfunctions. Alternatively, it may be possible to merely introduce the apples or other objects to the water bath without deeply immersing them, in which case the baffle 45 would not be necessary.

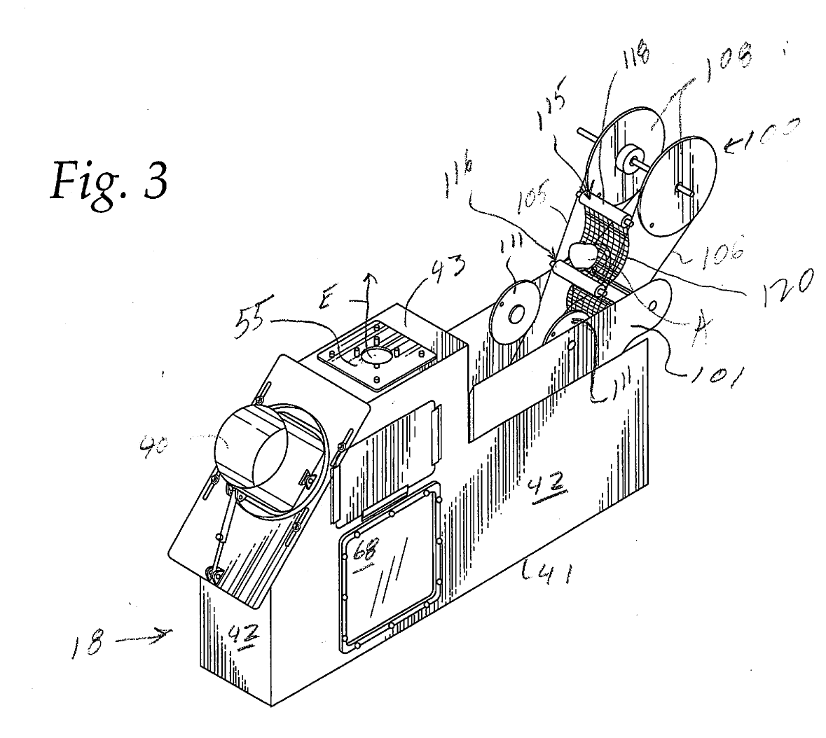

The extraction conveyor 100 here comprises two separated endless side belts 105, 106 which are routed over drive pulleys 108 and locating idlers 109, 110, 111, 112. Extending between the belts 105, 106 are a series of leading and following cross rods 115, 116 which can be padded with rubber or other resilient covers 118 (FIG. 3) if desired. To reliably engage, extract, lift and transport the apples A or other objects in accordance with the invention, a flexible mesh net or other pliable foraminous or fenestrated material extends between each of the leading cross rods 115 and its partnered trailing cross rod 116 to form a depending curvilinear cradle 120 extending between the side belts 105, 106.

When the pulleys 108-112 are arranged as shown in FIGS. 2 and 3, a diagonally ascending belt run 125 orients correspondingly ascending cradles 120 so as to engage and gently extract an apple A or other floating object with a diagonally upward scooping motion. Water adjacent the Apple A or other objects drains through the mesh and back into the tank rear section 48. The Apple A or other object is discharged from the conveyor 100 as the object-containing cradle 120 turns over the top drive pulley 108. Each discharged apple A can be there engaged by a cross conveyor 22 (FIG. 1) for examination and further transport and processing.

If desired, the lower pulleys 110, 111 can be located relatively close to the tank bottom 41 so that the cradles 120 will engage sunken items resting on the bottom of the tank. If desired, the cradles 120 can be provided in a continuous array between each of the cross rods 115, 116 so that no object can travel between the side belts 105, 106 without being engaged by a cradle 120, and so that each object will be engaged by a cradle and then will be lifted out of the tank 18.

As indicated in FIG. 3, the tank 18 and the discharge conveyor 100 are relatively narrow; they are not much wider than the pneumatic transport tube 16 and its associated tank inlet 40 or the apples A or other objects being transported and handled. By confining the width of these mechanisms to dimensions ranging from just slightly wider than a single apple or object to a maximum width of less than twice the width of that apple or object, the floating apples A or objects are encouraged to form a single file, and each apple A or object is engaged and extracted from the tank 18 by a single conveyor cradle 120. The apples A or objects are thus delivered one at a time to the receiving cross conveyor so that they can be individually examined and further processed. Object organizing or distributing equipment thus may be unnecessary.

If desired, the discharge conveyor 100 can be mounted on a subframe 101 (FIG. 3), so that the conveyor can be conveniently removed from the tank 18 for maintenance or repair.

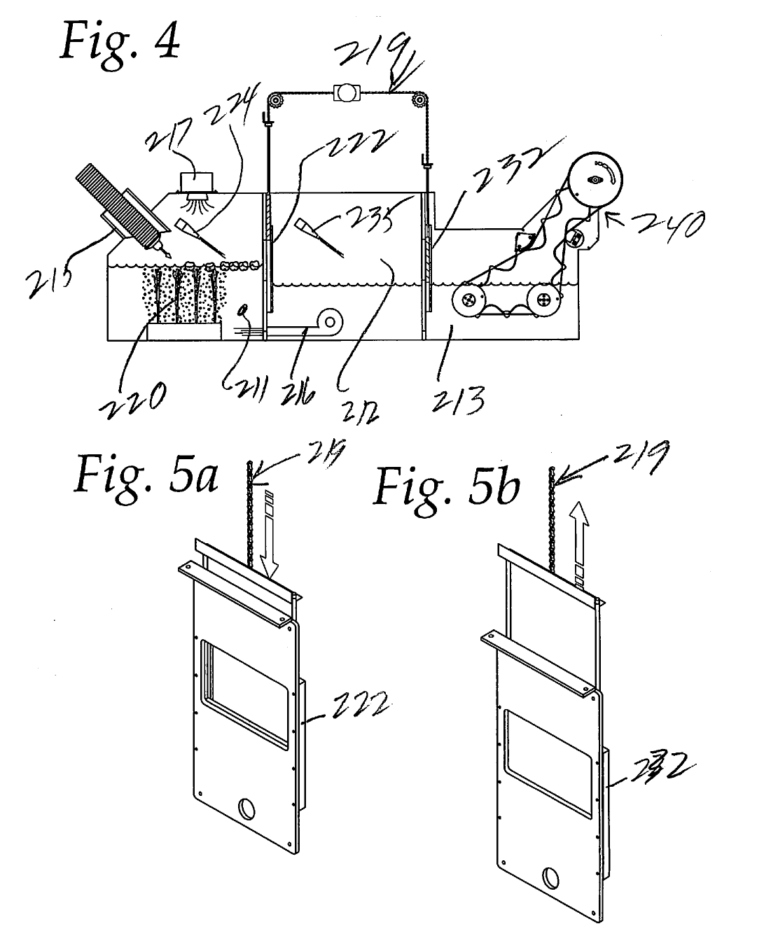

A second embodiment of the deceleration device is shown in FIGS. 4 through 7. Here, the deceleration device 200 takes the form of a tank divided into three sections 211, 212 and 213. Each of these sections 211, 212, and 213 contain a fluid such as water. Apples or other objects move rapidly toward the tank along pneumatic transport tubes (not shown) to a tube nozzle 215. A vacuum is maintained in these tubes and in the nozzle 215 by a conventional source of vacuum 217.

Apples and many other fruits and objects float when placed in water. As described above, these objects exit the pneumatic tube nozzle 215, and they are immersed in the water. Under some conditions, the momentum of the apples might carry the apples down into the water with sufficient force to impact the tank bottom and thus bruise or otherwise damage the apples. To inhibit this, flexible fingerlike elements 220 made of foam plastic or other suitable materials are mounted to the bottom of the first tank section 211 in positions to intercept and slow the travel of the apples or other objects being immersed in the water.

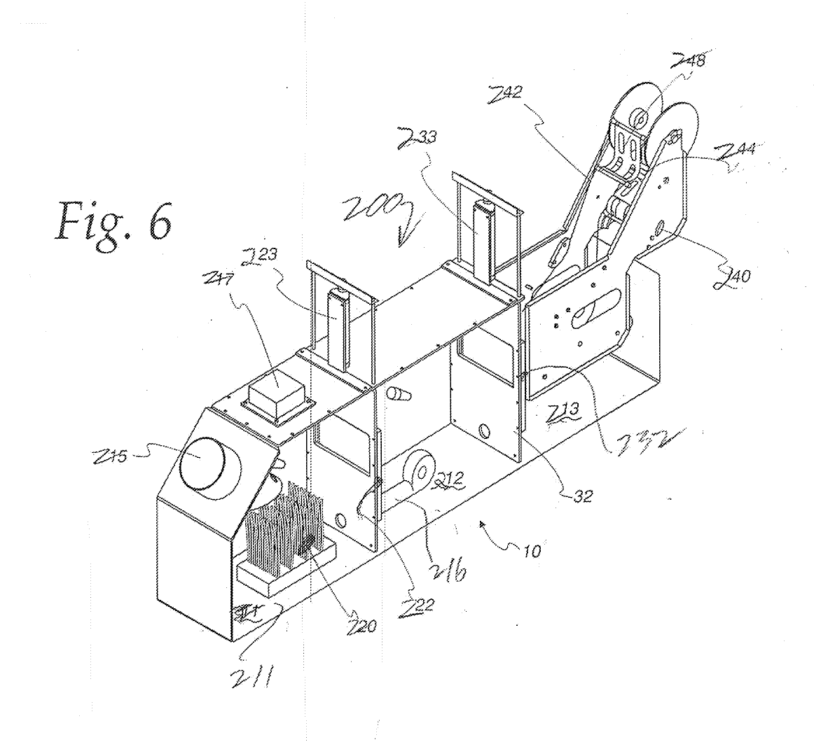

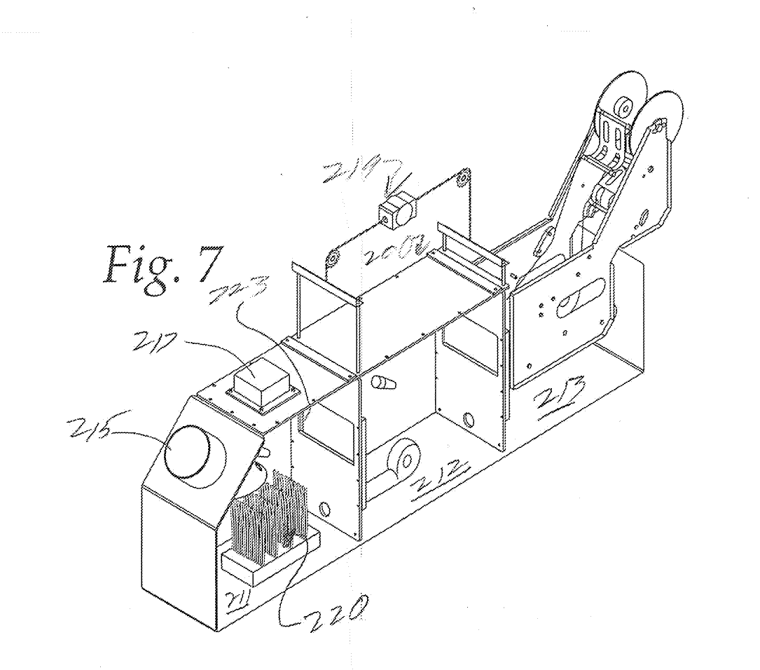

When a number of objects (for example, 20 to 30 apples) have been collected in the first tank section 211, a first gate 222 can be opened by a mechanical pulley arrangement 219 or a hydraulic device 223 as suggested in FIGS. 6 and 7. A water jet 224 shown in FIG. 4 can be provided to direct a flow of water, and if desired, air across the top of the water in this first section 211 so as to urge the floating apples from the first section 211 through the open gate 222 to the second section 212. As also illustrated in FIG. 4, a pump 216 can be provided to draw water from the second section 212 and return that water to the first section 211. Thus, there may be a difference in depth of water or fluid in the first and second sections of as much as one or 2 inches. Under these circumstances, the apples or other floating objects will flood through the gate 222 and into the second section 212.

After the floating objects have been delivered from the first section 211 to the second section 212, the first gate 222 is closed and a second gate 232 is opened to permit the floating objects to be directed or urged from the second section to the third section 213. It will be noted that, although a slight vacuum is provided in the first section, when the first gate 222 is closed and the second gate 232 is opened, both the second section 212 and the third section 213 experience ambient air pressure. Thus, the second section 212 and the gates 222 and 232 act as an air pressure lock between the reduced-air-pressure first section 211 and the ambient-air-pressure third section 213. The second gate 232 can be opened and closed by any suitable device such as a hydraulic cylinder 233 (FIG. 6). A water and/or air jet 235 can be provided to urge the floating objects from the second section 212 into the third section 213.

An extraction or transmission transition conveyor 240 can be connected to and partially submerged in the third section 213. Here this extraction conveyor 240 takes the form of opposed but spaced apart belts 242 and 244 between which are cradle like structures 248 adapted to engage and lift the floating objects out of the water in the third tank section 213. This conveyor can be like the extraction conveyor 100 described above.

1. A decelerator comprising a deceleration tank capable of holding a quantity of liquid for decelerating the travel motion of objects emanating from a delivery conveyor having an object delivery end in communication with the tank.

2. A deceleration tank and a quantity of liquid within the tank for decelerating the travel motion of objects emanating from a conveyor having an object delivery end in communication with the tank.

3. A decelerator according to claim 1 further comprising a delivery conveyor attachment for locating the delivery conveyor end at a predetermined position and orientation relative to the deceleration tank.

4. A decelerator according to claim 3 wherein the conveyor attachment includes means for adjusting the angle of the delivery conveyor end relative to the surface of liquid in the tank.

5. A decelerator comprising a deceleration tank according to claim 1 further including a baffle gate mounted within the tank and extending below a surface of a liquid held in the tank.

6. A decelerator comprising a deceleration tank according to claim 5 wherein said baffle gate partly divides the tank into a forward section and a rear section, the device further including a vacuum source functionally connected to the forward tank section for creating a partial vacuum in the forward tank section and in the delivery conveyor communicating with the forward tank section.

7. A decelerator comprising a deceleration tank according to claim 6 and further including an extraction conveyor for extracting objects from the deceleration tank.

8. A decelerator comprising a deceleration tank according to claim 6 further including an extraction conveyor means communicating with the tank rear section for extracting objects from the tank.

9. A decelerator comprising a deceleration tank according to claim 2 wherein the tank is at least partially enclosed by a bottom, sides and top, and a baffle gate dividing the tank into a forward section and a rear section, the deceleration tank further including a vacuum exhaust port in communication with the tank forward section and a vacuum source in communication with the exhaust part.

10. A decelerator comprising a deceleration tank according to claim 9 wherein said vacuum exhaust port further includes means to adjust the amount of vacuum created over a liquid in the forward section of the tank.

11. A decelerator comprising a deceleration liquid tank and an extraction conveyor.

12. A decelerator according to claim 11 wherein the deceleration liquid tank is at least partly filled with a fluid and wherein at least part of the extraction conveyor is in communication with the fluid.

13. A decelerator according to claim 11 wherein the extraction conveyor comprises at least one endless belt and at least one cradle for engaging objects in the deceleration liquid tank.

14. A decelerator according to claim 13 wherein the extraction conveyor comprises a plurality of side belts, a plurality of cross rods extending between and attached to the side belts, and a plurality of cradles extending between and attached to the cross rods.

15. A decelerator according to claim 14 wherein at least part of one run of said belt is oriented so that said cradle is moved diagonally upwardly through and out of said liquid so as to gently extract an object engaged by said cradle.

16. A decelerator according to claim 11 wherein the deceleration tank and the extraction conveyor are adapted to decelerate the travel of, and to convey, objects of predetermined general size, and wherein the width of the extraction conveyor is at least as wide as, but no more than twice as wide as, the width of the objects of predetermined size.

17. A decelerator according to claim 16 wherein the deceleration liquid tank is at least as wide as, but no more than twice as wide as, the width of the objects of predetermined size.

18. A decelerator according to claim 11 wherein the extraction conveyor is mounted on a subframe.

19. A method of receiving objects being transported by a pneumatic tube wherein a partial vacuum has been created in the tube in front of the objects being transported, the method comprising the step of delivering the transported objects from the pneumatic tube to a liquid bath in a deceleration tank.

20. A method according to claim 19 further including the step of:
causing a transported object to be immersed in the liquid bath in the forward tank section; and
causing the object to travel under a baffle gate and thence into a rear tank section.

21. A method according to claim 20 further including the step of allowing the object to rise toward the surface of liquid in the rear tank section.

22. A method according to claim 20 further including the step of extracting the object from the liquid bath by a conveyor in communication with the rear tank section.

23. A method according to claim 19 further comprising the step of delivering the transported objects to the liquid bath at an angle of substantially 45 degrees to the surface of the liquid.

24. A method according to claim 22 wherein the step of extracting the object from the liquid bath tank by a conveyor includes the step of engaging the object by a conveyor cradle and lifting the object from the liquid bath by the cradle.

25. A method according to claim 22 wherein the step of extracting the object from the liquid bath tank includes the step of lifting the object from the liquid bath along a path of travel which is oriented at an acute angle to the surface of the liquid.

26. A decelerator having a multi-sectioned deceleration tank for use with a pneumatic tube object delivery system, the tank comprising, in combination:
a first section adapted to contain a quantity of liquid;
an inlet for connection to an outlet of the pneumatic tube object delivery system and an outlet for connection to a vacuum source;
a second section selectively connectable to the first section so as to permit fluid and objects to flow from the first section into the second section; and
a third section selectively connectable to the second section so as to permit objects to flow from the second section into the third section.

27. A decelerator according to claim 26 further including a conveyor means for extracting the objects from the third tank section.

28. A decelerator including a deceleration tank according to claim 26 further including finger elements mounted in the first section for engaging and decelerating the travel of objects arriving in the first tank section.

29. A decelerator including a deceleration tank according to claim 26 wherein at least the first tank section is pressure tight.

30. A decelerator including a deceleration tank according to claim 26 further including nozzle means for urging objects in the first tank section into the second tank section.

31. A decelerator including a deceleration tank according to claim 26 further including means for creating a partial vacuum in the first section.

32. A decelerator including a deceleration tank according to claim 26 further including pump means for pumping fluid from the second or third tank sections into the first tank section.

33. A decelerator including a deceleration tank according to claim 27 further including gate means defining a selectively openable barrier between the first tank section and the second tank section.

34. A decelerator including a deceleration tank according to claim 28 further including gate means defining a selectively openable barrier between the second tank section and a third tank section.

35. A method of transferring floatable objects from a pneumatic tube delivery system to an extraction device comprising the steps of:
delivering the objects to a fluid bath in a first tank section;
directing the objects to a second tank section which is selectively in fluid and pressure communication with the first tank section; and
thereafter isolating the first tank section from the second tank section and directing the objects from the second tank section into a third tank section when the second and third tank sections are in fluid and pressure communication with each other.

36. A method according to claim 35 further including the step of extracting the objects from the third tank section.

37. A method according to claim 35 further comprising the step of opening and closing a gate between the first tank section and the second tank section.

38. A method according to claim 35 further comprising the step of opening and closing a gate between the second tank section and the third tank section.
